(19) United States
(12) Patent Application Publication
(10) Pub. No.: US 2012/0278178 A1
(43) Pub. Date: Nov. 1, 2012

(54) Method for Delivering Highly Relevant Advertisements in a Friendly Way through Personal Robots

(76) Inventor: Hei Tao Fung, Fremont, CA (US)

(21) Appl. No.: 13/098,392

(22) Filed: Apr. 29, 2011

(51) Int. Cl. G06Q 30/00

(52) U.S. Cl. 705/14.66

(57) ABSTRACT

A method for delivering highly relevant advertisements in a friendly way through personal robots is disclosed. Internet has become ubiquitous and delivering advertisements through internet in the form of emails and Web contents is common. However, unsolicited advertisements are often considered annoying and ignored. Delivering highly relevant advertisements that users have a good chance of responding to them positively is challenging. Many personal robots are able to recognize the users through face recognition techniques and speech recognition techniques. Personal robots through frequent interactions with users gather data and preferences about users. The information gathered helps identifying the relevant advertisements specific to users. Also, the personal robots are able to deliver the advertisements in a friendly way that users may perceive positively.

### FIELD OF THE INVENTION

The present invention relates to robots and advertisement delivery. More specifically the present invention relates to using personal robots to deliver highly relevant advertisements to users.

### BACKGROUND

Internet has become ubiquitous, and delivering advertisements in the form of emails and Web contents to internet users is common. However, unsolicited advertisements are considered annoying and often referred to as SPAMs. Users tend to ignore them. Delivering highly relevant advertisements that users have a good chance of responding to them positively is challenging. That said, there are some successful methods. For example, Google delivers advertisements associated with the search results while the search keywords serve as filtering criteria of advertisements. Tripadvisor.com presents advertisements relevant to a tourist spot when users are searching and reading the travel commentaries about the tourist spot. Those methods tend to require initiation from users, often through Web search. Delivering unsolicited advertisements is more challenging as users may not be actively looking for something.

Personal robots are robots for personal use: entertainment, education, domestic help, etc. Many personal robots are able to recognize the users through face recognition techniques and speech recognition techniques and interact with users. As users and personal robots are bonded, personal robots can be an effective means to deliver unsolicited advertisements, and the advertisements delivered can be highly relevant by filtering advertisements based on user data gathered through bonding activities.

### SUMMARY OF THE INVENTION

An object of the present invention is to deliver advertisements that are highly relevant to users in a friendly way using personal robots. The personal robots herein are capable of interaction with users, identifying users through face and speech recognition techniques and making conversation with users. Through bonding activities such as games and conversations over time, personal robots gather data about users and store user data in persistent storage. Personal robots query an advertisement server using the user data as filtering criteria. Personal robots further assess the opportune time when users are more receptive to suggestions and deliver the downloaded advertisement as a progressive series of questions, suggestions, and informational messages. Personal robots further analyze users' reaction to adjust the filtering criteria and advertisement delivery.

### BRIEF DESCRIPTION OF THE DRAWINGS/FIGURES

The present invention will be understood more fully from the detailed description that follows and from the accompanying drawings, which however, should not be taken to limit the disclosed subject matter to the specific embodiments shown, but are for explanation and understanding only.

FIG. 1 illustrates a preferred process in a preferred embodiment of the present invention.

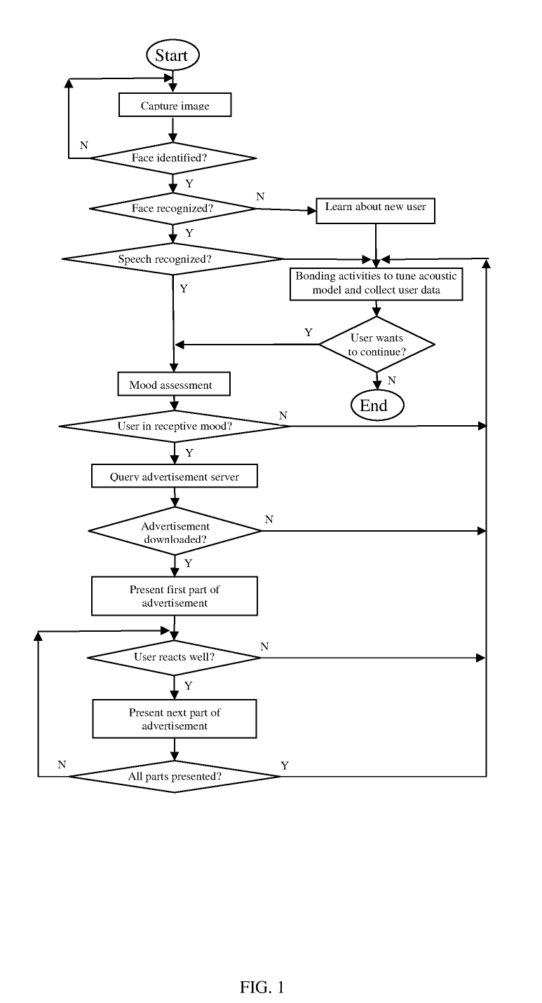

### DETAILED DESCRIPTION OF THE INVENTION

The personal robots in the present invention are capable of interaction with users. They comprise camera to capture images, microphones to capture sound, and speakers to play out synthesized speech. The personal robots are capable of identifying users through face and speech recognition techniques and communicating with users via artificial intelligence and speech synthesis.

Face recognition is automatic identification of a user from a digital image or a video frame. One of the ways to do that is comparing the selected facial features from the image and those from a facial database. A simple technique which is particularly suited for the preferred embodiment of the present invention is Principal Component Analysis (PCA) because of its speed and relatively small demand on memory. PCA, based on information theory concepts, seeks a computational model that best describes a face by extracting the most relevant information contained in that face. One well-known method is called eigenfaces. The approach is to find the eigenfaces of the covariance matrix of a set of face images. Every face image is represented by a linear combination of these eigenfaces. Recognition is performed by projecting an image onto the subspace spanned by the eigenfaces and then classifying the face by comparing its position in the face space with the positions of known individuals. Personal robots are supposed to be able to identify a small number of users. The eigenfaces method is particularly applicable.

Speech recognition converts spoken words, captured in an audio clip, into text. One of the statistical techniques is used in our preferred embodiment. An isolated speech recognition (ISR) speaker-dependent system is particularly applicable. During the bonding activities, the system can be trained by prompting the users to say certain words.

For example, through face recognition, a personal robot identifies a new user; the personal robot memorizes the new face, and it then asks a series of questions like meeting a new friend. The questions would solicit single-word answers so that the acoustic model of the speech recognition system is trained for the user. The acoustic model is then tied to the face memorized.

The text obtained from speech recognition can be analyzed through an artificial intelligence (A.I.) system. There are well-known techniques that an A.I. system forges a personality, integrating memories, emotion, knowledge of many words, sentence structure, and pattern-matching capabilities. That system is sometimes referred to as a chat bot. The system receives text as input and generates text as output. The A.I. system can reside on the personal robots or reside on an internet server. Personal robots with active internet connection may leverage the A.I. system on the internet server.

Speech synthesis is the artificial production of speech from text. Unit Selection Synthesis (USS) technique generates quite natural speech. In our preferred embodiment, if the personal robot receives text from the A.I. system local to the personal robot, USS technique is used. If the personal robot has access to the A.I. system on an internet server, the A.I. system can perform the speech synthesis and send the speech back to the personal robot. The A.I. system on the internet server may have more powerful computing resource; in that case, the Hidden Markov Model Synthesis technique may be used.

The personal robots in the present invention gather user data through bonding activities over time. The user data is stored in a relational database in a persistent storage, either locally on the personal robots or remotely on an internet server. The bonding activities comprise games, conversations, educational applications, and others. Over time, the users' age group, gender, favorites, family structure, and behaviors are recorded in the relational database.

The personal robots in the present invention assess a good time to deliver an advertisement. Receptiveness is the readiness to accept new ideas, suggestion, opinions, and, as the focus of the present invention, advertisements. Psychological studies show that angry people narrowly focus on the person or thing that is upsetting them, and people in good or relaxed mood tend to be more receptive. The personal robots in the present invention apply both explicit and implicit mood assessment techniques. Explicit mood assessment is evaluating user's mood through questioning. In the simplest form, it would be a question of “How are you today?” Implicit mood assessment aims at assessing users' mood while user is unaware of their mood being assessed. One method is to detect positive and negative words in conversations.

The personal robots in the present invention query an advertisement server with users' data as filtering criteria. The advertisement server is accessible through a local network or internet. The advertisement server comprises a database of advertisements associated with keywords that facilitate the filtering of advertisements by users' data. The filtered advertisements are downloaded to the personal robots.

An advertisement in the present invention is structured as a progressive series of questions, suggestions, or informational messages. The level of details increases as the presentation of the advertisement progresses. The design is to solicit users' reaction before going further in the presentation of the advertisement. The structure of an advertisement is designed and keyed in by an operator into the advertisement database, and it is supposed to facilitate the personal robots to assess users' reactions to determine whether to proceed further or abort the presentation of the advertisement.

The embodiments described above are illustrative examples and it should not be construed that the present invention is limited to these particular embodiments. Thus, various changes and modifications may be effected by one skilled in the art without departing from the spirit or scope of the invention as defined in the appended claims.

1. A method for delivering highly relevant advertisements in a friendly way through personal robots, comprising:
(a) using a personal robot that can recognize a user;
(b) using said personal robot to gather data about said user through bonding activities;
(c) storing user data gathered over time in persistent storage;
(d) using said personal robot to assess a good time to deliver advertisements to said user;
(e) using user data as filtering criteria of advertisements;
(f) downloading filtered advertisements to said personal robot from an advertisement server; and
(g) using said personal robot to deliver said filtered advertisements to said user.

2. The method as in claim 1, wherein said personal robot comprises camera, microphone, and speaker.

3. The method as in claim 1, wherein said personal robot recognizes a user using face recognition techniques and speech recognition techniques.

4. The method as in claim 1, wherein said personal robot can recognize a plurality of users.

5. The method as in claim 1, wherein said bonding activities comprise educational applications, games, and conversations.

6. The method as in claim 1, wherein said persistent storage can reside on said personal robot or on a network server.

7. The method as in claim 1, wherein said user data gathered over time is stored in a relational database.

8. The method as in claim 1, wherein using said personal robot to assess a good time to deliver advertisements to said user comprises mood assessment.

9. The method as in claim 1, wherein said filtering criteria comprise age group, gender, favorites, and choices made.

10. The method as in claim 1, wherein said filtering criteria are dynamically adjusted over time according to data gathered through bonding activities and user reaction to advertisements delivered.

11. The method as in claim 1, wherein said advertisement server is accessible through a local network or internet.

12. The method as in claim 1, wherein using said personal robot to deliver said filtered advertisements to said user, comprising:
(a) formatting an advertisement into a series of questions, suggestions, or informational messages with progressive level of details;
(b) presenting the first question, suggestion, or informational message; and
(c) proceeding to the next questions, suggestions, or informational messages or cutting short the advertisement delivery based on reaction of said user.
